(19) United States
(12) Patent Application Publication
(10) Pub. No.: US 2015/0225947 A1
(43) Pub. Date: Aug. 13, 2015

(54) Modular Glazing System

(71) Applicants: Neil McClelland, New York, NY (US); Nina Choe, Los Angeles, CA (US)

(72) Inventors: Neil McClelland, New York, NY (US); Nina Choe, Los Angeles, CA (US)

(73) Assignee: HOK PRODUCT DESIGN, LLC, Culver City, CA (US)

(21) Appl. No.: 14/616,843

(22) Filed: Feb. 9, 2015

Related U.S. Application Data
(60) Provisional application No. 61/937,257, filed on Feb. 7, 2014.

(51) Int. Cl. E04B 7/02; E06B 1/18; E06B 1/16; E04B 7/04; E04B 2/96

(52) U.S. Cl. CPC E04B 7/028; E04B 7/04; E04B 2/967; E06B 1/16; E06B 1/18

(57) ABSTRACT

In a modular glazing system, a plurality of rafter units is affixed to stiffener arms of a plurality of node stiffeners so as to connect the node stiffeners and so that the rafter units define at least one polygonal shape. A frame unit is affixed to each rafter unit. An elongated spacer is placed on each frame unit. The elongate spacer has a glazing placement surface with a predetermined angular relationship to the frame unit. A glazing unit, having a shape corresponding to the polygonal shape defined by at least three rafter units, is placed on the glazing placement surface of the elongated spacer on each frame. Each glazing unit is sealed to the glazing placement surfaces and to the frame units.

### CROSS-REFERENCE TO RELATED APPLICATION(S)

This application claims the benefit of U.S. Provisional Patent Application Ser. No. 61/937,257, filed Feb. 7, 2014, the entirety of which is hereby incorporated herein by reference.

### BACKGROUND OF THE INVENTION

1. Field of the Invention

The present invention relates to architectural framing systems and, more specifically, to a modular glazing system.

2. Description of the Related Art

Architectural glazing can be found in glass curtain walls, window walls, skylights, punched windows and other applications. Most architectural glazing systems employ pre-manufactured standard windows, catalogue glazing elements around which a design is created, or fully custom glazing elements that are made for a specific building.

Architects often use glazing to add to the aesthetics of a design. Increasingly, they employ three-dimensional glazing to add texture to the façade of a building. However, employing the current state of the art to complex glazing designs often requires complex adaptation of the existing systems.

Therefore, there is a need for a modular glazing system that will allow design of complex glazing effects using a modular glazing system.

### SUMMARY OF THE INVENTION

The disadvantages of the prior art are overcome by the present invention which, in one aspect, is a glazing system that includes a plurality of node stiffeners. Each node stiffener includes a plurality of stiffener arms extending radially outwardly from a central portion. Each of a plurality of elongated rafter units is affixed to two different ones of the plurality of node stiffeners. Each rafter unit includes a base surface and two oppositely disposed walls extending upwardly therefrom so as to define a trough. Each rafter unit includes an elongated T-shaped structure that is disposed within the trough and that runs lengthwise along a portion of the rafter unit. Each of a plurality of elongated frame units includes a lateral portion that is mounted on and affixed to a different one the rafter units. Each frame unit includes a vertical portion extending upwardly from the lateral portion. Each of a plurality of elongated spacers is disposed on a selected frame unit and each spacer includes a glazing placement surface having a predetermined angular relationship with the lateral portion of the selected frame unit. Each of a plurality of glazing units has a shape corresponding to a polygon defined by at least three of the rafter units. A first sealant seals each glazing unit to at least three of the frame units.

In another aspect, the invention is a frame system for a glazing placement that includes a plurality of node stiffeners. Each node stiffener includes a plurality of stiffener arms extending radially outwardly from a central portion. Each of a plurality of elongated rafter units is configured to be affixed to two different ones of the plurality of node stiffeners. Each rafter unit includes a base surface and two oppositely disposed walls extending upwardly therefrom so as to define a trough. Each rafter unit includes an elongated T-shaped structure that is disposed within the trough and that runs lengthwise along a portion of the rafter unit. Each of a plurality of elongated frame units includes a lateral portion that is configured to be mounted on and affixed to a different one the rafter units. Each frame unit includes a vertical portion extending upwardly from the lateral portion. Each of a plurality of elongated spacers is configured to be disposed on a selected frame unit and each spacer includes a glazing placement surface having a predetermined angular relationship with the lateral portion of the selected frame unit.

In yet another aspect, the invention is a method of building a glazing system, in which a plurality of rafter units is affixed to stiffener arms of a plurality of node stiffeners so as to connect the node stiffeners and so that the rafter units define at least one polygonal shape. A frame unit is affixed to each rafter unit. An elongated spacer is placed on each frame unit. The elongate spacer has a glazing placement surface with a predetermined angular relationship to the frame unit. A glazing unit, having a shape corresponding to the polygonal shape defined by at least three rafter units, is placed on the glazing placement surface of the elongated spacer on each frame. Each glazing unit is sealed to the glazing placement surfaces and to the frame units.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is an exploded view of one embodiment of a modular glazing system.

FIG. 2A is a cross sectional view of a node employed in the embodiment shown in FIG. 1.

FIG. 2B is a perspective view of a rafter unit.

FIG. 2C is a perspective view of a framing unit.

FIG. 3 is a perspective view of a detail of part of a node.

FIG. 4 is a top perspective view of a glazing unit made from several glazing modules.

FIGS. 5A-5D are a series of top views showing different layers used to construct a node.

FIG. 6 is a cross sectional view of a node mounted to a wall.

FIG. 7A is a top plan view of a six arm node stiffener.

FIG. 7B is a perspective view of a three arm node stiffener.

FIG. 7C is a top plan view of a four arm node stiffener with variable angle stiffener arms.

FIG. 8 is a perspective view of a glazing system employing glazing units of two different shapes.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” As used herein, an item that extends radially starts at a first end at a central location and is disposed along a ray that extends outwardly from the central location.

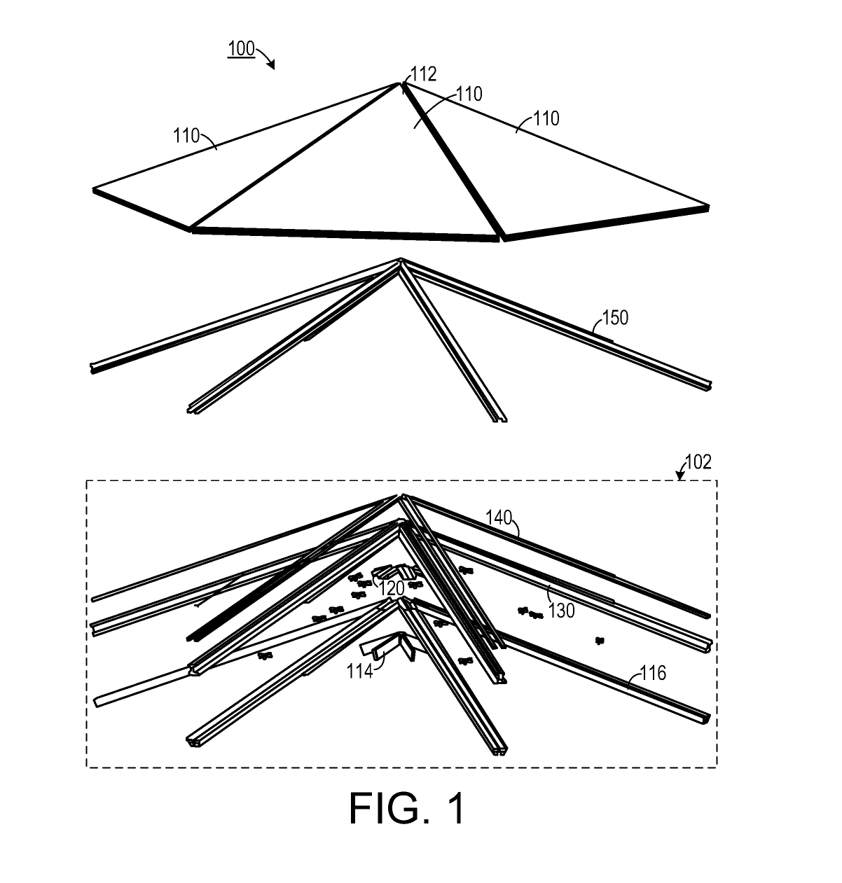

As shown in FIGS. 1, 2A-2C, 3-4 and 5A-5D, one embodiment of a glazing system 100, includes a plurality of factory assembled modular glazing units 110 that are configured to fit into a site assembled frame system 102. The modular glazing units 110 could include standardized geometries, including geometries such as triangular units, trapezoidal units, square units and rectangular units. Typically, the modular glazing units 110 would include one, two or three parallel vision glass panes separated by spacers and sealed along the periphery. Non-vision glazing, such as translucent and textured insulating materials, may also be used, depending on the visual effect desired by the architect. Shadow boxes may also be employed in embodiments in which the architect wants to give the impression of a glazing unit being a window while covering up something behind it.

The frame system 102 includes a plurality of rigid rafter units 116 that are configured to extend from a node 112. The rafter units 116 are each secured to different rays of the node stiffener 114, typically with a bolt 118. A flexible silicone boot 120 is placed inside the rafter unit 116 at the node and an elongated frame 130 is assembled with a connecting plate 132 that is secured to the rafter unit 116 with a bolt 134. A site sealant 152 is applied to the frame 130 to prevent air and water from entering the frame 130. The rafter units 116 are sloped and may be continuously drained to the outside to control any water that may enter the system through failure of the frame sealant 152. The rafter units 116 could also include a separate condensation catchment system continuously drained to a collection point on the inside of the glazing system.

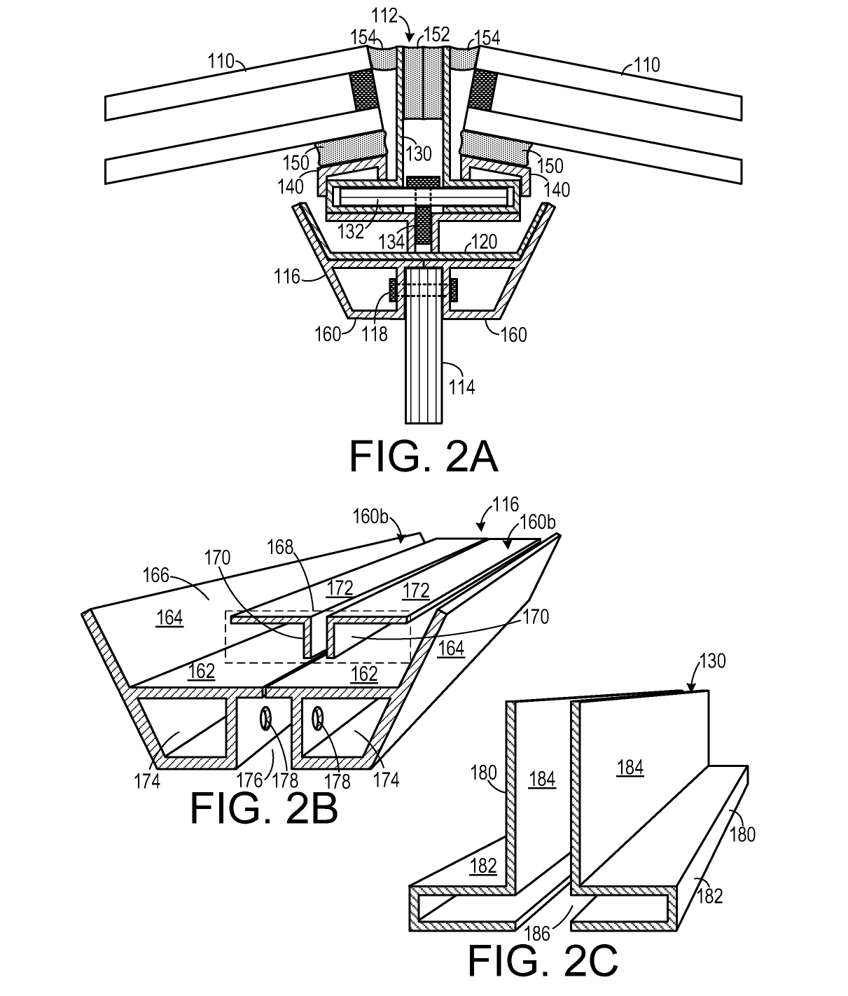

As shown in FIG. 2A and 2B, one embodiment of a rafter unit 116 can include two rafter sub-units 160a and 160b, each of which is reflectively symmetrical with the other. Each of the rafter sub-units 160a and 160b could be made, for example, from extruded aluminum. Each of the rafter sub-units 160a and 160b includes a base surface 162 and a wall 164 extending upwardly from the base surface 162. Each of the rafter sub-units 160a and 160b is shaped that when they are put together, they define a recess 176 that is complementary in shape to the stiffener arm 114 to which it is affixed and a trough 166. A bolt hole 178 is defined by each rafter sub-unit 160a and 160b to facilitate bolting to the stiffener arm 114. The bolt holes 178 can be accessed through an orifice 174 formed in each of the rafter sub-units 160a and 160b. Each rafter sub-unit 160a and 160b has an L-shaped structure formed from a first wall 170 extending upwardly from the base surface 162 and a second wall 172 extending outwardly and laterally from the top of the first wall 170. When the rafter sub-units 160a and 160b are placed together and affixed to the stiffener arm 114, the two L-shaped structures form a T-shaped structure 168 that is disposed in the trough 166 and that runs lengthwise therewith. The T-shaped structure 168 stops short of the end of the rafter unit 116 to allow for placement of the flexible silicone boot 120 in the trough 166 at the node 112.

As shown in FIG. 2A-2C, the elongated frame 130 can include two elongated extruded members 180, each of which includes a sideways-oriented U-shaped portion 182 extending outwardly and a vertical plate 184 extending upwardly therefrom. The two extruded members 180 are reflectively symmetric and, when placed together on top of the T-shaped structure 168, define an elongated rectangular passage 186. An elongated connecting plate 132 is disposed in the passage 186 and a bolt 134 passes through the connecting plate 132 and is screwed into the space between the first walls 170 of the two L-shaped members, thereby affixing the frame 130 to the rafter unit 116. Once the frame 130 is secured to the rafter unit 116, a sealant 152 (such as a silicone sealant) is used to seal the vertical plates 184 of the two extruded members 180 to each other.

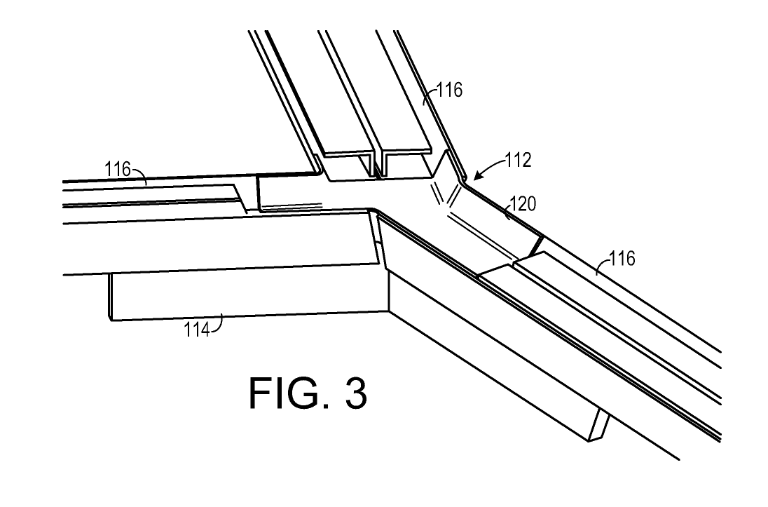

As shown in FIG. 3, at a node 112, the rafter units 116 are secured to the node stiffener 114 and a flexible boot 120 that is complimentary in shape to the trough in the area of the node 112 is placed therein. Such a flexible boot 120 could include, for example, silicone or another type of flexible material. A boot made of a rigid material could be used in certain embodiments.

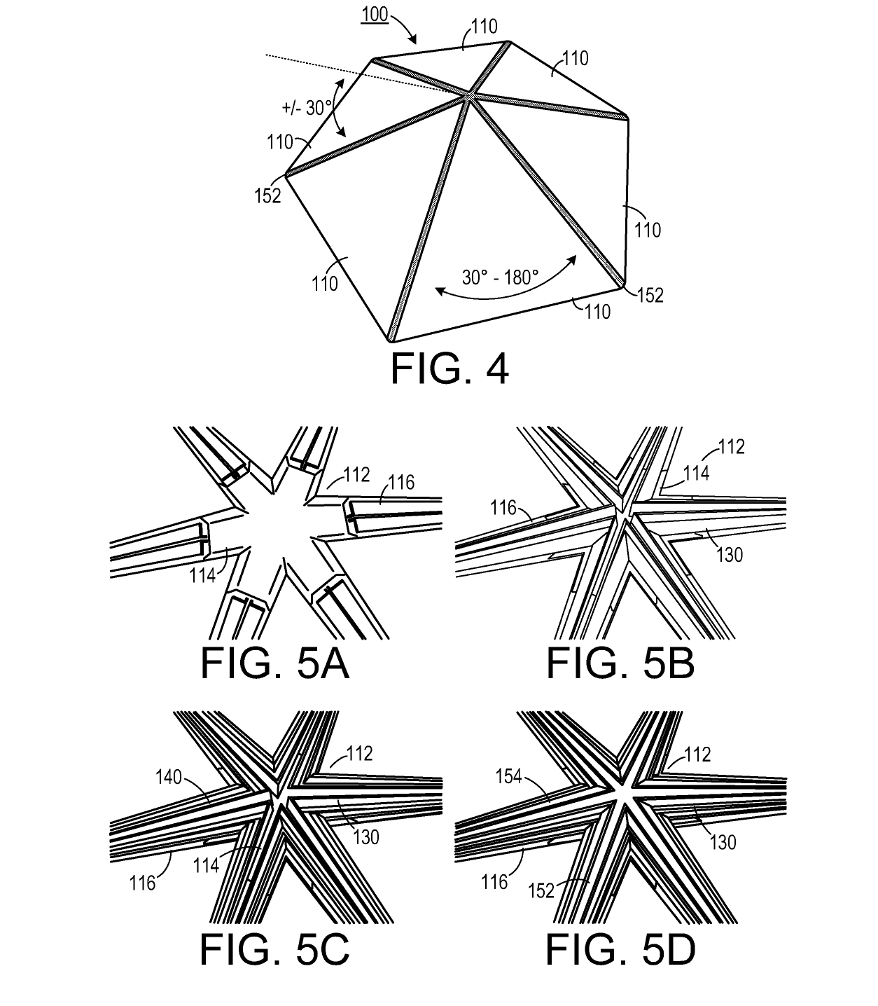

A six-sided embodiment is shown in FIG. 4, in which six triangular glazing units have been assembled as a pyramid. This embodiment might find application, for example, as a skylight. In building a framing system for this type of embodiment, as shown in FIGS. 5A-5D, the rafter units 116 are affixed to the node stiffener at the node 112 and the flexible boot 114 is placed therein. The frame units 130 are then secured to the rafter units 116, as shown in FIG. 5B, and then spacers 140 are placed on the frame units 130. While all of the other components disclosed thus far can have standard sizes, the spacer 140 has leg dimensions that correspond to the desired angle of the glazing units 110 relative to each other at the node 112. Sealants 150 are applied to the spacers 140 and the glazing units 110 are placed thereon. Additional sealants 154 seal any gaps between the frame 130 and the glazing units 110. In an alternative embodiment, the spacers 140 may have a spherical and serrated contact surface with the rafter unit 116 to allow for small and discrete angular adjustments using a single extrusion.

By using standard dimension glazing units 110 and by selecting a certain number of rays in the frame system 102, the architect is able to design three-dimensional glazing systems of many different shapes and depths using standard components.

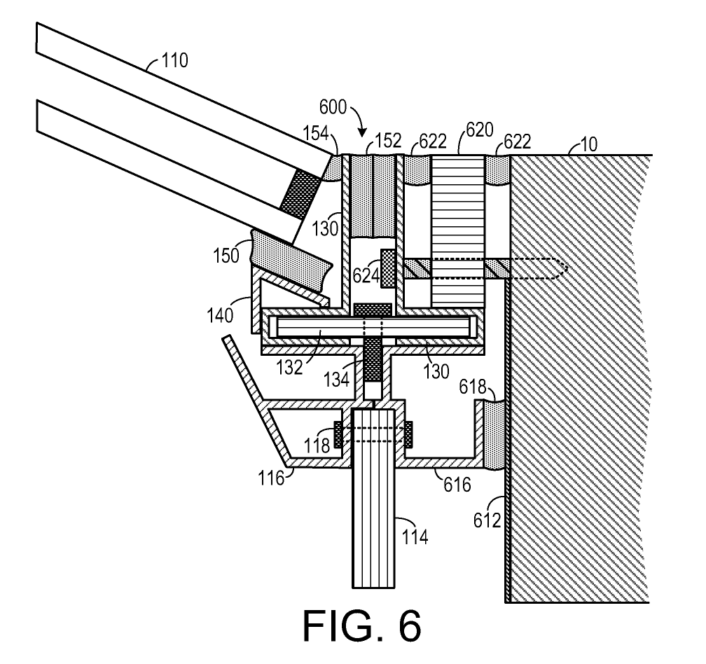

One embodiment of a node portion 600, as shown in FIG. 6, can be adapted for coupling the framing system to a wall 10. In this embodiment, a spacer 140 is placed on the outward side of the frame unit 130 and a spacing block 620 is placed to the other side. A bolt 624 is used to affix the frame unit 130 and the spacing block 620 to the wall 10. A Sealant 622 (such as a silicone sealant) is applied to seal the spacing block 620 to the framing unit 130 and the wall 10. A portion 616 of the rafter unit 616 can be made with a U-shaped bottom section with a vertical wall. A vapor barrier 612 may be applied to a portion of the wall 10 and a sealant 618 can be applied to seal the vertical wall to the vapor barrier 612.

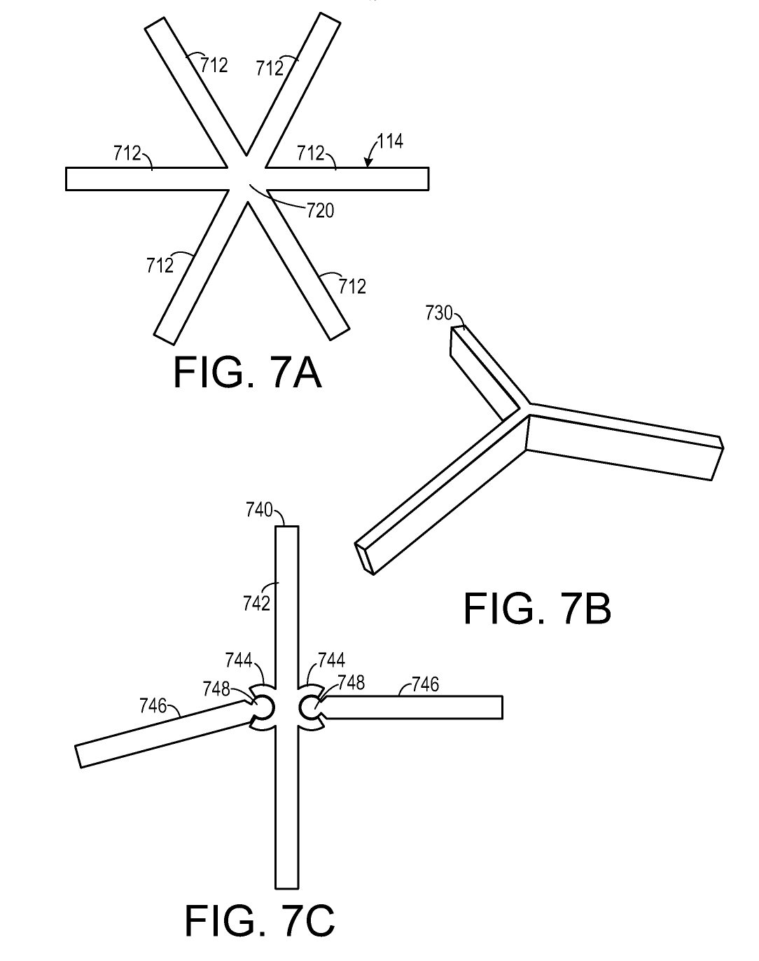

Various configurations of node stiffener may be employed to achieve the desired effect. For example, as shown in FIG. 7A, a six-stiffener arm configuration 114 may be employed in making a six-sided pyramid of the type shown in FIG. 4. The example shown in FIG. 7A includes six equal angle stiffener arms 712 extending radially outwardly from a central node portion 720. In embodiments in which an upwardly-pointed pyramid is made, the stiffener arms 712 will be slanted downwardly from the central node portion 720. This will result in a symmetric shape. Non-symmetric shapes can be achieved by varying the angles between the stiffener arms 712. A three sided pyramidal shape can be achieved using the node stiffener configuration 730 shown in FIG. 7B. As shown in FIG. 7C, a variable configuration node stiffener unit 740 may be employed to allow several angular configurations without having to manufacture a different type of node stiffener for each configuration. Such a unit 740 can include at least one fixed stiffener arm 742 and one or more variable angle stiffener arms 746 that are hingedly attached to the fixed stiffener arm 742. The variable stiffener arms 746 can terminate at one end in a vertical cylinder 748 that fits into a complimentary-shaped socket 744, which allows lateral movement of the stiffener arm 746 and adjustment of the stiffener arm 746 into a desired angular relationship with at least one adjacent stiffener arm. Typically, the stiffener arms extend outwardly and radially from a central location.

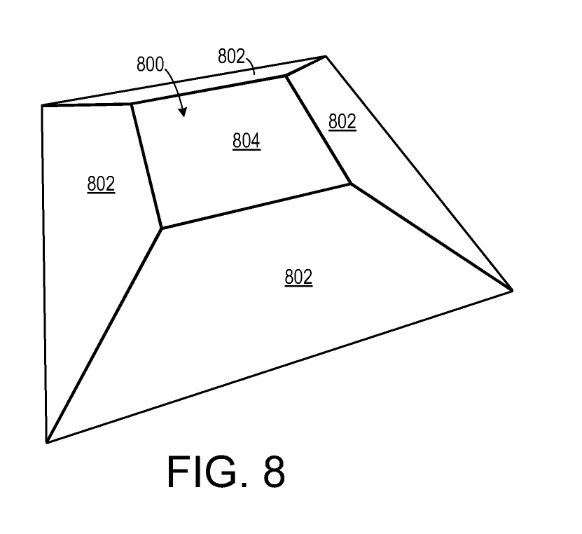

A truncated pyramidal glazing system 800 is shown in FIG. 8. This system 800 employs a central square glazing unit 800 surrounded by four trapezoidal glazing units 802. The node stiffener units used to connect the central square glazing unit 800 to the trapezoidal glazing units 802 could include a three-arm system 730 of the type shown in FIG. 7B.

Many of the components such as the rafter units, the framing units, the spacer units, and the like used herein could be made from materials including: extruded aluminum, composites, steel, wood, plastic, and other materials known to the art of glazing.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims rather than being limited to the specifically described embodiments above.

What is claimed is:

1. A glazing system, comprising:
(a) a plurality of node stiffeners, each node stiffener including a plurality of stiffener arms extending radially outwardly from a central portion;
(b) a plurality of elongated rafter units, each rafter unit being affixed to two different ones of the plurality of node stiffeners, each rafter unit including a base surface and two oppositely disposed walls extending upwardly therefrom so as to define a trough, each rafter unit including an elongated T-shaped structure disposed within the trough and running lengthwise along a portion of the rafter unit;
(c) a plurality of elongated frame units, each frame unit including a lateral portion that is mounted on and affixed to a different one the rafter units, each frame unit including a vertical portion extending upwardly from the lateral portion;
(d) a plurality of elongated spacers, each disposed on a selected frame unit and each spacer including a glazing placement surface having a predetermined angular relationship with the lateral portion of the selected frame unit;
(e) a plurality of glazing units, each glazing unit having a shape corresponding to a polygon defined by at least three of the rafter units; and
(f) a first sealant that seals each glazing unit to at least three of the frame units.

2. The glazing system of claim 1, further comprising a second sealant that seals each glazing unit to the glazing placement surfaces of the elongated spacers.

3. The glazing system of claim 1, wherein each rafter unit has two opposite ends and wherein each T-shaped structure stops short of at least one of the ends, the glazing system further comprising a flexible silicon boot with a shape complimentary to the troughs of the rafter units affixed to a node stiffener and placed therein so as to cover gaps between the rafter units.

4. The glazing system of claim 1, wherein at least one of the stiffener arms is hingedly attached to the center portion, thereby allowing the stiffener arms to have a plurality of angular relationships relative to each other.

5. The glazing system of claim 1, wherein each of the plurality of stiffener arms has a vertically oriented rectangular cross section.

6. The glazing system of claim 1, wherein each T-shaped structure includes two L-shaped members, each L-shaped member including a first wall extending upwardly from the base surface of the rafter unit and a second wall extending outwardly from a top edge of the first wall, a space defined between the first walls of the two L-shaped members.

7. The glazing system of claim 6, wherein each of the frame units comprises:
(a) two extruded members, each defining a sideways-oriented U-shaped portion and a vertical plate extending upwardly therefrom, the two extruded members being placed on top of the T-shaped structure so that the U-shaped portions face each other and define a passage;
(b) an elongated connecting plate disposed in the passage;
(c) a bolt passing through the connecting plate and secured between the first walls of the two L-shaped members; and
(d) a third sealant that seals the vertical plates of the two extruded members to each other.

8. The glazing system of claim 6, configured to be secured to a wall and further comprising a bolt that secures a selected one of one of the extruded members to the wall.

9. The glazing system of claim 1, wherein the rafter units and the framed units comprise extruded aluminum.

10. The glazing system of claim 1, wherein the glazing units comprise at least a single pane of vision glass.

11. A frame system for a glazing placement, comprising:
(a) a plurality of node stiffeners, each node stiffener including a plurality of stiffener arms extending radially outwardly from a central portion;
(b) a plurality of elongated rafter units, each rafter unit configured to be affixed to two different ones of the plurality of node stiffeners, each rafter unit including a base surface and two oppositely disposed walls extending upwardly therefrom so as to define a trough, each rafter unit including an elongated T-shaped structure disposed within the trough and running lengthwise along a portion of the rafter unit;
(c) a plurality of elongated frame units, each frame unit including a lateral portion that is configured to be mounted on and affixed to a different one the rafter units, each frame unit including a vertical portion extending upwardly from the lateral portion; and
(d) a plurality of elongated spacers, each elongated spacer configured to be disposed on a selected frame unit and each spacer including a glazing placement surface having a predetermined angular relationship with the lateral portion of the selected frame unit.

12. The frame system of claim 11, wherein each rafter unit has two opposite ends and wherein each T-shaped structure stops short of at least one of the ends, the glazing system further comprising a flexible silicon boot with a shape complimentary to the troughs of all rafter units affixed to a node stiffener and configured to be placed therein so as to cover gaps between the rafter units.

13. The frame system of claim 11, wherein at least one of the stiffener arms is hingedly attached to the center portion, thereby allowing the stiffener arms to have a plurality of angular relationships relative to each other.

14. The frame system of claim 11, wherein each of the plurality of stiffener arms has a vertically oriented rectangular cross section.

15. The frame system of claim 11, wherein each T-shaped structure includes two L-shaped members, each L-shaped member including a first wall extending upwardly from the base surface of the rafter unit and a second wall extending outwardly from a top edge of the first wall, a space defined between the first walls of the two L-shaped members.

16. The frame system of claim 15, wherein each of the frame units comprise:
(a) two extruded members, each defining a sideways-oriented U-shaped portion and a vertical plate extending upwardly therefrom, the two extruded members configured to be placed on top of the T-shaped structure so that the U-shaped portions face each other and define a passage;
(b) an elongated connecting plate disposed in the passage; and
(c) a bolt configured to pass through the connecting plate and to be secured between the first walls of the two L-shaped member.

17. The frame system of claim 15, configured to be secured to a wall and further comprising a bolt that is configured to secure a selected one of one of the extruded members to the wall.

18. The frame system of claim 11, wherein the rafter units and the framed units comprise extruded aluminum.

19. A method of building a glazing system, comprising the steps of:
(a) affixing each of a plurality of rafter units to a different stiffener arm of a plurality of node stiffeners so as to connect the node stiffeners and so that the rafter units define at least one polygonal shape;
(b) affixing a frame unit to each rafter unit;
(c) placing an elongated spacer on each frame unit, the elongate spacer having a glazing placement surface with a predetermined angular relationship to the frame unit;
(d) placing a glazing unit, having a shape corresponding to the polygonal shape defined by at least three rafter units, on the glazing placement surface of the elongated spacer on each frame; and
(e) sealing the glazing unit to the glazing placement surfaces and to the frame units.

20. The method of claim 19, wherein each rafter unit has two opposite ends and wherein each T-shaped structure stops short of at least one of the ends, the method further comprising the step of placing a flexible silicon boot, having a shape complimentary to the troughs of all rafter units affixed to a node stiffener, in the trough so as to cover gaps between the rafter units.

21. The method of claim 19, wherein at least one of the stiffener arms is hingedly attached to the center portion, and further comprising the step of adjusting the stiffener arm that is hingedly attached to the center portion so as to have a desired angular relationship relative to another stiffener arm.
